(19) United States
(12) Patent Application Publication
(10) Pub. No.: US 2006/0082508 A1
(43) Pub. Date: Apr. 20, 2006

(54) Wireless WAN antenna

(76) Inventors: Paul J. Doczy, Cypress, TX (US); Earl W. Moore, Cypress, TX (US); Stacy L. Wolff, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/969,094

(22) Filed: Oct. 19, 2004

(51) Int. Cl. H01Q 1/24

(52) U.S. Cl. 343/702

(57) ABSTRACT

A portable electronic device, including a base mechanically coupled to a display enclosure with a hinge, is built. The display enclosure includes at least one WAN antenna configured to rotate about an axis such that when closed the antenna forms part of the display enclosure, and when rotated to an open position the antenna extends above the display enclosure.

### FIELD OF THE INVENTION

The present invention relates generally to the field of wireless networks and more specifically to RF antennas for use in wireless networks.

### BACKGROUND OF THE INVENTION

As wireless networks become more and more common, many mobile computing devices are incorporating network hardware within the portable computer. Signal integrity correlates to network speed so designers work to provide effective RF antennas within portable electronic devices in such ways that signal integrity is maximized. Prior solutions include the use of external RF antennas that electrically couple to the portable device, or the placement of RF antennas within a display enclosure. External RF antennas require the portable device to provide an external RF antenna connector, taking up valuable space on the exterior of the enclosure. Also, external RF antennas are vulnerable to damage since they are typically attached along one of the sides of the enclosure where they may inadvertently be bumped or otherwise impacted. Placement of RF antennas within a display enclosure, particularly for laptop computers, solves some of the problems inherent in external RF antennas, but also results in other difficulties. For example, by placing an RF antenna within a display enclosure, the antenna is limited in size to that of the display, there is possible degradation of the signal integrity due to the presence of display hardware in close proximity to the antenna, and the antenna is subject to damage during installation.

### SUMMARY OF THE INVENTION

A portable electronic device, including a base mechanically coupled to a display enclosure with a hinge, is built. The display enclosure includes at least one WAN antenna configured to rotate about an axis such that when closed the antenna forms part of the display enclosure, and when rotated to an open position the antenna extends above the display enclosure.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a view of a portable electronic device including a body and a display enclosure according to the present invention.

FIG. 2A is a side view of a display enclosure including a WAN antenna in a closed position according to the present invention.

FIG. 2B is a side view of a display enclosure including a WAN antenna in an open position according to the present invention.

FIG. 3 is a front view of a display enclosure including two WAN antennas according to the present invention.

FIG. 4 is a flowchart of a method for incorporating a WAN antenna into a display enclosure according to the present invention.

### DETAILED DESCRIPTION

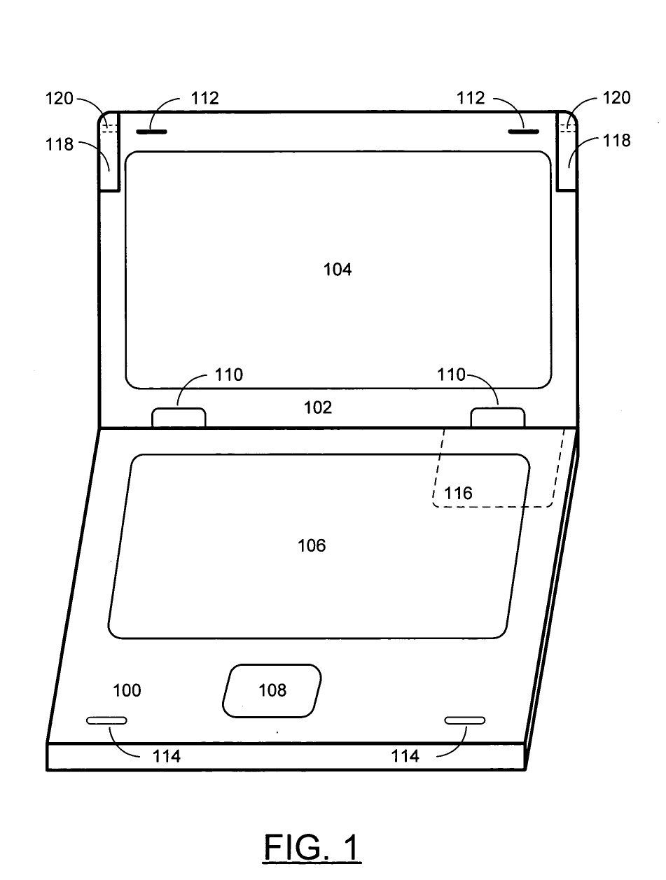

FIG. 1 is a view of a portable electronic device including a body and a display enclosure according to the present invention. In an example embodiment of the present invention, a portable electronic device including a body 100, and a display enclosure 102 is provided. Within the display enclosure 102 is a display 104. The body 100 includes a keyboard 106 and a touch pad 108. The display enclosure 102 is mechanically coupled to the body 100 by two hinges 110. When closed, the display enclosure 102 is locked to the body 100 by two latches 112 which lock into latch receptacles 114 within the body 100. Within the body 100 is a wireless network device 116 used to communicate with any available wireless network. The display enclosure 102 also includes two WAN antennas 118 mechanically coupled to the display enclosure 102 by two pins 120 in such a manner that the WAN antennas 118 may rotate about the pins 120 such that when rotated they extend above the top of the display enclosure 102. Those of skill in the art will recognize that the wireless network device 116 shown in this example embodiment of the present invention as residing in the body 100 of the portable electronic device may in other embodiments within the scope of the present invention, actually be located in other places, such as the display enclosure, or even external to the portable electronic device. By incorporating the WAN antennas 118 into the display enclosure 102, several advantages to prior art solutions are obtained. First, when the display enclosure is opened from the body 100, the WAN antennas 118 are near the highest point of the portable electronic device resulting in improved reception of the wireless network signals. This height advantage is further extended when the WAN antennas 118 are rotated about the pins 120 such that they extend above the display enclosure. Also, improved antenna performance may be obtained since the antenna has more external area away from the display 104 than a solution incorporating the antenna within the display enclosure 102. Also, multiple antennas 118 may be used to provide diversity. A single antenna 118 may be used in conjunction with an on-board antenna to provide either diversity, or different frequency or polarization characteristics of the RF antenna.

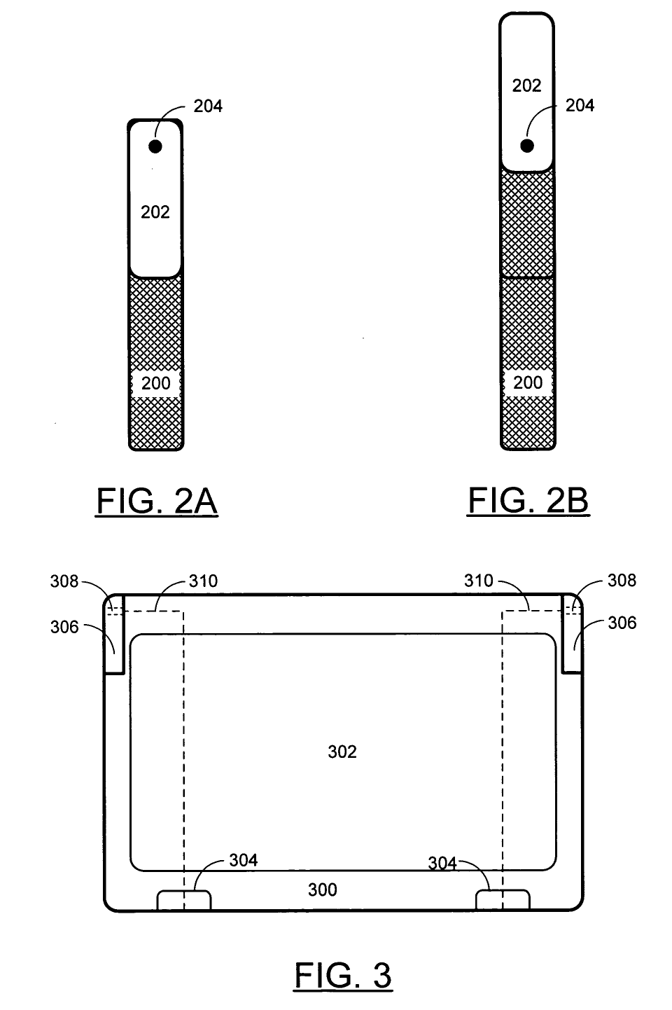

FIG. 2A is a side view of a display enclosure including a WAN antenna in a closed position according to the present invention. In this example embodiment of the present invention a display enclosure 200 is mechanically coupled with a WAN antenna 202 with a pin 204. The antenna 202 is configured to rotate about the pin 204. When the antenna 202 is rotated approximately 180 degrees about the pin 204 it is configured to extend above the top of the display enclosure 200, increasing signal strength of the wireless network. When the antenna 202 is in a closed position as shown in this figure, the antenna 202 does not extend beyond the extent of the display enclosure 200 in any dimension, and is thus protected from damage. Those of skill in the art will recognize that many other antenna shapes may be used within the scope of the present invention, and that this antenna configuration simply an example embodiment of the present invention.

FIG. 2B is a side view of a display enclosure including a WAN antenna in an open position according to the present invention. In this example embodiment of the present invention, the WAN antenna 202 as shown in FIG. 2A is rotated approximately 180 degrees about the pin 204 into an open position. In the open position, the antenna 202 extends above the top of the display enclosure 200, increasing signal strength of the wireless network. Those of skill in the art will recognize that the position of the WAN antenna 202 may be varied as desired to maximize reception of the wireless network signals.

FIG. 3 is a front view of a display enclosure including two WAN antennas according to the present invention. In this example embodiment of the present invention, a display enclosure 300 similar to that of FIGS. 1, 2A, and 2B is provided including a display 302, hinges 304, and two WAN antennas 306. The two WAN antennas 306 are mechanically coupled with the display enclosure through pins 308, and are electrically coupled with a wireless network device (not shown in this figure) through wires 310 and the pins 308. Those of skill in the art will recognize that while this example embodiment of the present invention shows the WAN antennas 306 electrically coupling with a wireless network device through two wires running through the two hinges 304 and two pins 308, many other methods may be used to electrically couple the WAN antennas 306 with a wireless network device.

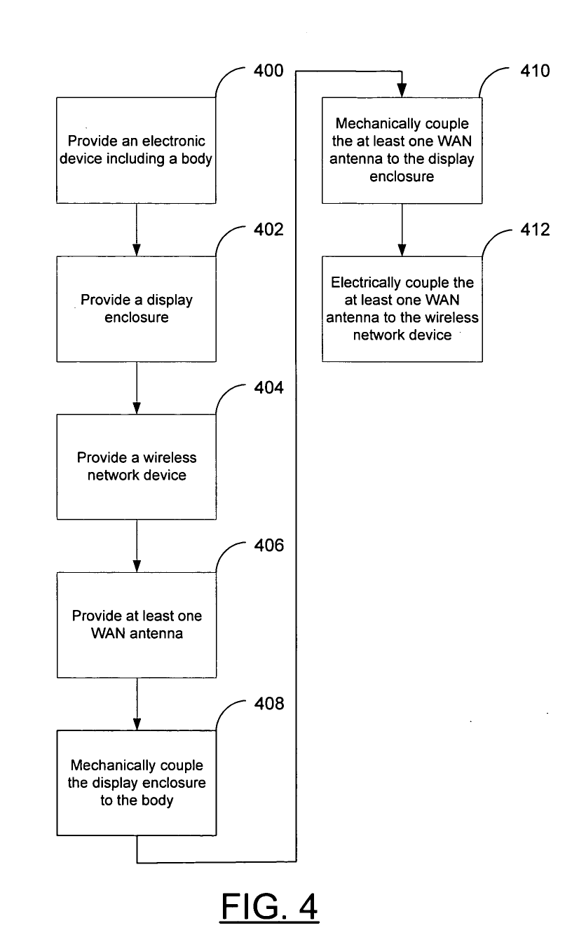

FIG. 4 is a flowchart of a method for incorporating a WAN antenna into a display enclosure according to the present invention. In a step 400, an electronic device including a body is provided. In a step 402, a display enclosure is provided. In a step 404, a wireless network device is provided. In a step 406, at least one WAN antenna is provided. In a step 408, the display enclosure is mechanically coupled to the body. In a step 410, the at least one WAN antenna is mechanically coupled to the display enclosure in a manner allowing rotation of the at least one WAN antenna about an axis, such that when the WAN antenna is in an open position it extends above the top of the display enclosure, and when in a closed position it does not extend beyond the extent of the display enclosure in any dimension. In a step 412, the at least one WAN antenna is electrically coupled to the wireless network device.

The foregoing description of the present invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A device comprising:
a body;
a wireless network device; and
a display enclosure mechanically coupled with said body, including at least one WAN antenna electrically coupled with said wireless network device;
wherein said at least one WAN antenna is mechanically coupled with said display enclosure, and configured to rotate about an axis, such that when said WAN antenna is in an open position it extends above the top of said display enclosure, and when in a closed position it does not extend beyond the extent of said display enclosure in any dimension.

2. A device as recited in claim 1,
wherein said at least one WAN antenna is mechanically coupled with said display enclosure by at least one pin, and is configured to rotate about said pin.

3. A device as recited in claim 2,
wherein said wireless network device is enclosed within said body; and
wherein said at least one WAN antenna is electrically coupled with said wireless network device through said at least one pin.

4. A device as recited in claim 1,
wherein said display enclosure is mechanically coupled with said body by one or more hinges.

5. A device as recited in claim 4,
wherein said wireless network device is enclosed within said body; and
wherein said at least one WAN antenna is electrically coupled with said wireless network device through said one or more hinges.

6. A device as recited in claim 1,
wherein said body includes at least one latch receptacle, and
wherein said at least one latch is configured to mechanically couple with said at least one latch receptacle when said display enclosure is closed.

7. A device as recited in claim 1,
wherein said body includes a keyboard.

8. A device as recited in claim 1,
wherein body includes a touch pad.

9. A device as recited in claim 1,
wherein said display enclosure includes a display.

10. A method for incorporating a WAN antenna into electronic device, comprising the steps of:
a) providing an electronic device including a body;
b) providing a display enclosure;
c) providing a wireless network device;
d) providing at least one WAN antenna;
e) mechanically coupling the display enclosure to the body;
f) mechanically coupling the at least one WAN antenna to the display enclosure in a manner allowing rotation of the at least one WAN antenna about an axis, such that when the WAN antenna is in an open position it extends above the top of the display enclosure, and when in a closed position it does not extend beyond the extent of the display enclosure in any dimension; and
g) electrically coupling the at least one WAN antenna to the wireless network device.

11. A method as recited in claim 10,
wherein the at least one WAN antenna is mechanically coupled with the display enclosure by at least one pin, and is configured to rotate about the pin.

12. A device as recited in claim 11,
wherein the wireless network device is enclosed within the body; and
wherein the at least one WAN antenna is electrically coupled with the wireless network device through the at least one pin.

13. A method as recited in claim 10:
wherein the display enclosure is mechanically coupled to the body by one or more hinges.

14. A method as recited in claim 13:
wherein the wireless network device is enclosed within the body; and
wherein the at least one WAN antenna is electrically coupled with the wireless network device through the one or more hinges

15. A device as recited in claim 10:
wherein the body includes at least one latch receptacle, and
wherein the at least one latch is configured to mechanically couple with the at least one latch receptacle when the display enclosure is closed.

16. A method as recited in claim 10:
wherein the body includes a keyboard.

17. A method as recited in claim 10:
wherein the body includes a touch pad.

18. A method as recited in claim 10:
wherein the display enclosure includes a display.
